(19) United States
(12) Patent Application Publication
(10) Pub. No.: US 2002/0152676 A1
(43) Pub. Date: Oct. 24, 2002

(54) Plant water absorbing container

(76) Inventor: Di Chan, Taipei (TW)

Correspondence Address: RABIN & CHAMPAGNE, P.C., Suite 500, 1101 14th STREET, N.W., WASHINGTON, DC, 20005, US

(21) Appl. No.: 09/839,219

(22) Filed: Apr. 23, 2001

(51) Int. Cl. A01G 9/02

(52) U.S. Cl. 47/65.5

(57) ABSTRACT

A plant water absorbing container is disclosed. A water tank is filled with water. At least one supporting frame is disposed in the water tank. A net frame slight smaller than the opening of the water tank is installed above the supporting frame. A plurality of water absorbing cottons are disposed above the net frame. Two distal ends of each water absorbing cotton are sunk in the water. Each position on the net frame for disposing the water absorbing cotton is installed with a flat culture disk. Each culture disk has a bottom which is drilled with a plurality of via holes. Each culture disk is filled with nourish material and plant. The water absorbing cotton generates a siphonage so that water permeates into the water absorbing cotton from the center portion thereof. The air for the root of a plant can flow through the hole at the lateral hole of the water tank. Therefore, plant will acquire sufficient nutriment and water. Thus, the works of irrigation and applying fertilizer can be completed at the same time. Moreover, the time for cultivating plant can be saved. Moreover, the objects of clearness and environment protection are achieved.

### FIELD OF THE INVENTION

The present invention relates to a plant water absorbing container, and especially to water tank for implanting various plants, moreover, the wetness of the nutriment is controlled by a simple way so that it is unnecessary to sprinkle water for a long time.

### BACKGROUND OF THE INVENTION

Implanting plants or flowers is popular for many peoples. However, those implanting plants or flowers need a great deal of time and works to take care of the flowers or plants. Many works are necessary for taking care of the plants and flowers. Not like cats or dogs, they can present their feeling and body conditions, but the plants or flowers are often placed at corners of a room and often, the master does not care them a long period of time so that the plants or flowers will wither gradually or get a sick. To sprinkle water to the cultivated plants or flowers is also a big trouble. Too much water will cause the roots of plants to be corroded, while too little water will cause the plants to wither. Therefore, the amount of water can not be controlled accurately. Therefore, there is an eager demand for an article can resolve such as problem so that the people implanting the plants are unnecessary to sprinkle water.

Furthermore, referring to FIGS. 5, and 6, a water absorption flowerpot is illustrated, which includes a main pot, a water basin, a supporting ring, and a water absorbing device. The basin serves to contain water. The top of the main pot has an opening and the bottom thereof has seat legs. A plurality of water draining holes and an engaging holes are formed at the bottom thereof. A flange is installed at an edge of the opening. The main pot can be disposed in the water basin. The ring has an outer diameter larger than that of the opening of the basin so as to be installed at the top of the basin. The water absorbing device has a cotton, an clamping rod, and a toggle. The clamping rod is a hollow rod. The edge of top thereof has a protrusion for being embedded into an embedding hole of the main basin. A respective ring edge is formed at a lower side of the protrusion. A plurality of lobes protrude from the lower edge of the clamping rod. The thickness of lobes are enlarged from the upper side to the lower side. The outer side of the clamping rod has thread and the inner side of the toggle has respective thread. The cotton core is a tube body and can be installed in the clamping rod. The rod is screwedly installed with a toggle. According to the aforesaid structure, the water absorbing device is installed in the embedding hole of the main pot. Then, by the ring, they can be the assembled into the basin. The flange of the main pot exactly resists against the peripheral edge of the ring. Therefore, in this prior art way, the water absorption way is improved and the whole structure is complex and need a large cost. The way for absorbing water is to use a cotton core to absorb water from the basin to earth. As water is to be filled therein, the water in the basin must be below the main pot, otherwise water will directly flow into the main pot and then air near the root must be dispersed. Therefore, it can only be planted in the main pot and thus the application is narrow, even this prior art product has other applications.

### SUMMARY OF THE INVENTION

Accordingly, the primary object of the present invention is to provide a plant water absorbing container, wherein two sides of the water tank are installed with at least one holes which is lower than the net frame. A plurality of water absorbing cottons are disposed above the net frame. Two distal ends of each water absorbing cotton pass through the slits preset between the net frame and the water tank, and is sunk in the water. A water absorbing cotton is placed between the net frame and the culture disk so as to generate a siphonage so that water permeates into the water absorbing cotton from the center portion thereof. The air from the root of a plant can flow through the hole at the lateral hole of the water tank. Furthermore, the bottom of the culture disk is drilled with a plurality of via holes and the culture disk is flatly adhered to the surface of the water absorbing cotton. Therefore, the nourish material at the bottom of the culture disk may absorb water and then water transfers upwards. Therefore, plant will acquire sufficient nutriment and water.

Therefore, the defect that in the present invention, water flows out from the bottom of the bottle is improved. Therefore, the floor or ground will not become dirt by the leakage water. Furthermore, water-soluble fertilizer can be added to the water tank. Thus, the works of irrigation and applying fertilizer can be completed at the same time. Moreover, the time for cultivating outer plant can be saved.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a schematic view along line 2-2 of FIG. 1.

FIG. 3 is a schematic cross sectional view along 3-3 of FIG. 1.

FIG. 4 is a schematic cross sectional view of another embodiment in the present invention.

FIG. 5 is an exploded perspective view of a prior art design.

FIG. 6 is a schematic cross sectional view of a prior art design.

### DETAILED DESCRIPTION OF THE PREFERRED EMBODIMENTS

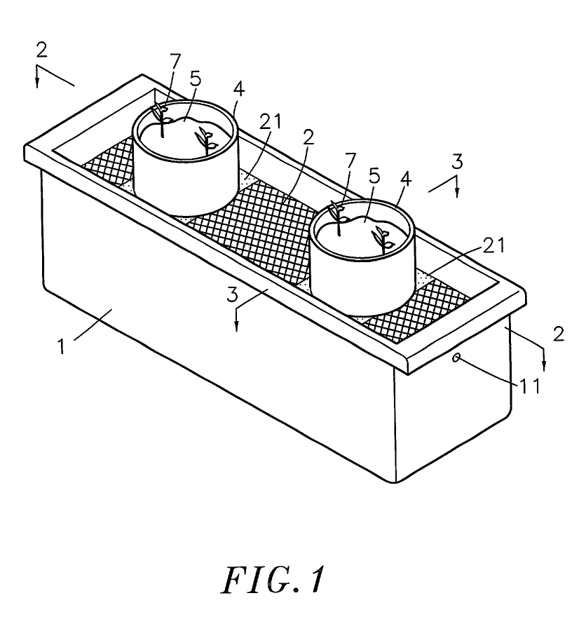

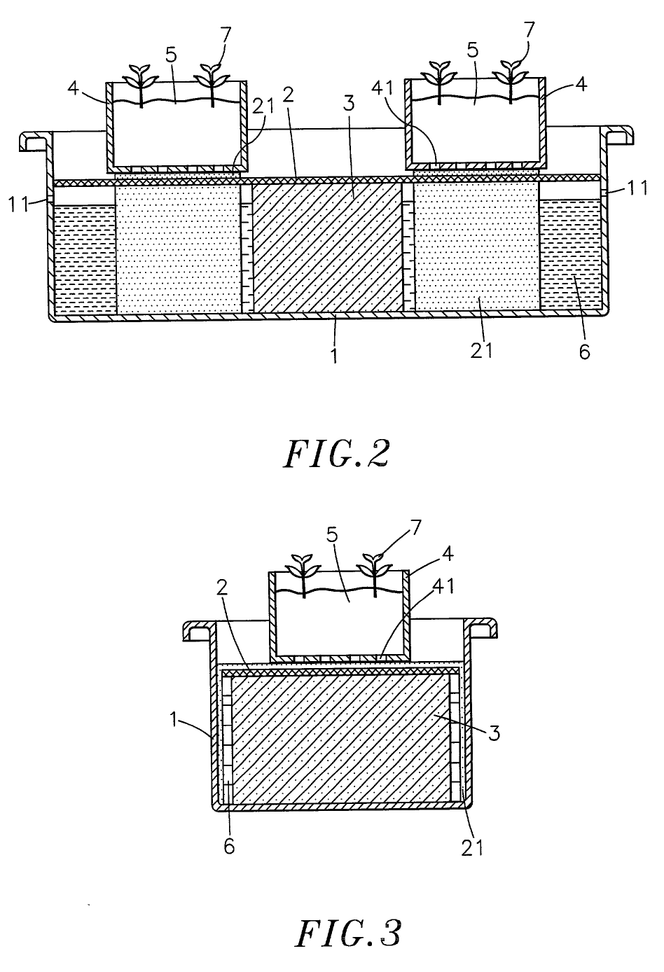

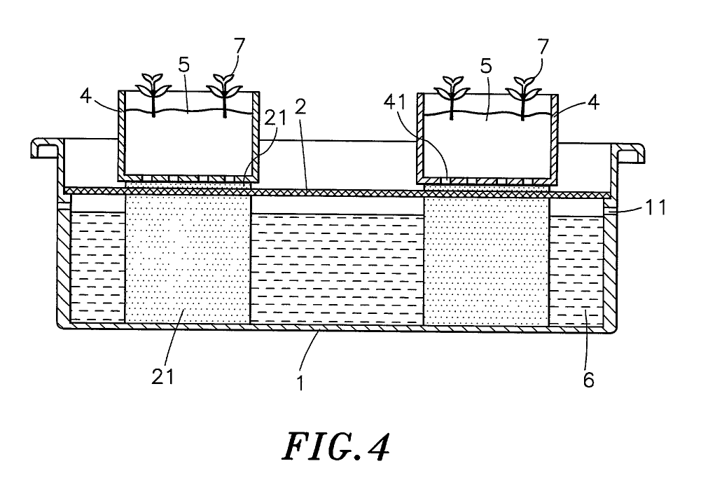

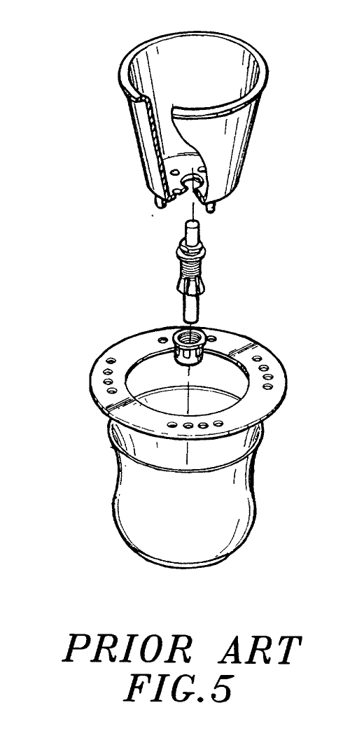

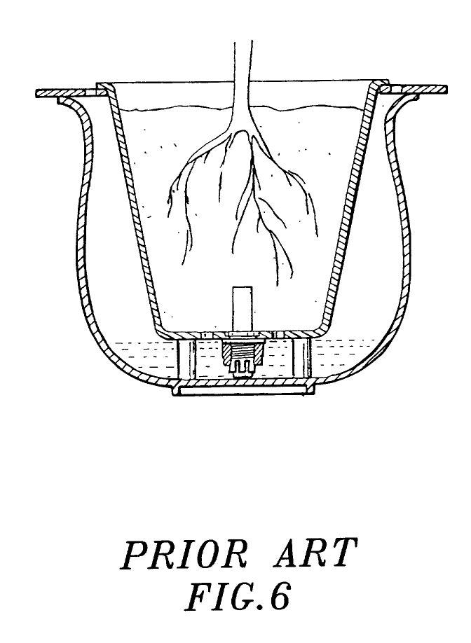

Referring to FIGS. 1, 2 and 3, in the present invention, a water tank 1 is filled with water 6. At least one supporting frame 3 is disposed in the water tank 1. A net frame 2 is installed above the supporting frame 3. Two sides of the water tank 1 are installed with at least one holes 11 which is lower than the net frame 2. A plurality of water absorbing cottons 21 are disposed above the net frame 2. Two distal ends of each water absorbing cotton 21 pass through the slits preset between the net frame 2 and the water tank 1, and is sunk in the water 6. Each position on the net frame 2 for disposing the water absorbing cotton 21 is installed with a flat culture disk 4. Each culture disk 4 has a bottom which is drilled with a plurality of via holes 4. Each culture disk 4 is filled with nourish material 5 and plant 7. Therefore, the present invention is formed, which serves to implant various plants or flowers and has a simple structure.

In the present invention, at least one culture disks 4 are placed on the net frame 2 of the water tank 1. A water absorbing cotton 21 is placed between the net frame 2 and the culture disk 4. The water absorbing cotton 21 has two distal ends which is sunk in the water 6 so as to generate a siphonage so that water permeates into the water absorbing cotton 21 from the center portion thereof. The air for the root of a plant can flow through the hole 11 at the lateral hole of the water tank 1. Furthermore, the bottom of the culture disk 4 is drilled with a plurality of via holes 41 and the culture disk is flatly adhered to the surface of the water absorbing cotton 21. Therefore, the nourish material 5 at the bottom of the culture disk 4 may absorb water 6 and then water transfers upwards. Therefore, plant 7 will acquire sufficient nutriment 5 and water. Furthermore, according to the required water of the plant 7, size of the via hole 41 at the bottom of the culture disk 4 is determined so as to adjust the amount of water. Alternatively, the water-soluble fertilizer can be added to the water 6 of the water tank 1. Thus, the works of irrigation and applying fertilizer can be completed at the same time. Moreover, the time for cultivating outer plant 7 can be saved.

Referring to FIG. 4, another embodiment of the present invention is illustrated, wherein the structure of the water tank 1 is modified. At a preset height of the water tank 1, the thickness is widened gradually so as to be formed with ladder shape inner wall for placing a net frame 2 in the water tank 1 directly without the supporting frame 3. Thereby, the net frame 2 becomes more stable without being tilt due to collision or falls to the bottom of the water tank 1. Therefore, the present invention can be installed conveniently and is stable.

Furthermore, in the present invention, the size of the net frame 2 of the water tank 1 can be modified according to the number of the culture disks 4 so as to implant various plants or flowers. In different environment, the amount can be increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A plant water absorbing container, a net frame being installed above a water tank, at least one water absorbing cotton is disposed above the net frame; distal ends of each water absorbing cotton being place on a bottom of the water tank, each position on the net frame for disposing the water absorbing cotton being installed with a flat culture disk; each culture disk having a bottom which is drilled with a plurality of via holes; each culture disk being filled with nutriment containing seeds of plants or flowers; as water being filled into the container, it will be absorb by the water absorbing cotton and then permeating two ends thereof; and then by each via hole, the water permeating the nutriment for implanting the seeds of plants or flowers without needing the sprinkling water

2. The plant water absorbing container as claimed in claim 1, wherein the net frame is supported by at least one supporting frames in the water tank for preventing the net frame to oscillate.

3. The plant water absorbing container as claimed in claim 1, wherein the net frame is placed directly above a circular inner wall of a ladder shape water tank.

4. The plant water absorbing container as claimed in claim 1, wherein one lateral wall of the water tank is formed with at least one hole.

5. The plant water absorbing container as claimed in claim 1, wherein the culture disk is made of plastics, acryl, glass, and the shape of the culture disk is designed for the requirement of practical application.
